(19) United States
(12) Patent Application Publication
(10) Pub. No.: US 2025/0289337 A1
(43) Pub. Date: Sep. 18, 2025

(54) POWER GENERATOR SYSTEM FOR SELF-CHARGING BATTERIES IN ELECTRIC VEHICLES

(71) Applicant: Julivan Costa Guimaraes, Londrina - Parana (BR)

(72) Inventor: Julivan Costa Guimaraes, Londrina - Parana (BR)

(21) Appl. No.: 19/010,968

(22) Filed: Jan. 6, 2025

(30) Foreign Application Priority Data
Mar. 13, 2024 (BR) 20 2024 004987 5

(51) Int. Cl. B60L 53/57; B60K 17/356; B60L 50/60; H02J 7/14

(52) U.S. Cl. CPC B60L 53/57; B60L 50/60; H02J 7/14; B60K 17/356

(57) ABSTRACT

The present disclosure refers to a set of engine electrical devices used in four-wheeled vehicles, with the insertion of a set of electrical coils (stator) and magnetic rotor with the aim of providing an energy-generating motor system to recharge the battery and increase autonomy of electric vehicles through displacement, a configuration applied to vehicles that provide the use of two and up to four motors on the front and rear wheels depending on the vehicle configuration, the motor on the rear wheels (1), the batteries (2), heatsink are demonstrated (3), consumption manager (4), charger manager (5), energy converter (6) and generators 1 and 2 (7) located on the front wheels, shows the wheel with the engine connected and the perspective of the wheel with the generator energy, the internal magnetic field generation area in the wheel (8) and demonstrates the stator assembly.

### CROSS-REFERENCE TO RELATED APPLICATION

This application claims priority to and takes the benefit of Brazilian patent application No. 202024004987 5 filed on Mar. 13, 2024, the contents of which is hereby incorporated by reference into the present disclosure.

### TECHNICAL FIELD

This Utility Model patent application refers to a set of electric motors used in four-wheeled vehicles (cars, trucks, tractors, buses), with the insertion of a set of electric coils (stator) and magnetic rotor with the aim of providing an energy-generating motor system to recharge the battery and increase the autonomy of electric vehicles through displacement.

### BACKGROUND

Combustion vehicle engines generally use regular gasoline as fuel, as it is cheaper and less expensive, however, added gasoline is essential to ensure greater engine cleanliness and greater fuel economy, however, such fossil fuels have been much questioned and contribute to environmental pollution.

In Brazil, the number of vehicles circulating has been increasing significantly and questions about the pollutants they cause are also increasing.

To minimize such problems, electric vehicles are currently required, when they must pollute less, contribute to the environment and provide savings for the driver.

As part of the state of the art, we highlight document BR 102024000465 5, from the applicant himself, which, according to his summary, refers to a “POWER GENERATOR ENGINE FOR CHARGING BATTERIES IN ELECTRIC MOTORCYCLES”, which consists of a set of equipment, electric motors installed in the front and rear wheels of motorcycles, called hubs, with the aim of providing energy to recharge the motorcycle battery with its own displacement in use, providing an increase in the vehicle's autonomy, when regenerative energy is supplied by the displacement of the motorcycle itself, t: the calculation is based on the energy set installed on the motorcycle, considering the configurations of traction motors, battery, charger and power generation motors; presents a configuration applied to motorcycles that provides the use of two engines on the front (1) and rear (3) wheels, batteries (2), a third central wind engine through the capture of air mass formed by the movement (4) and a main traction motor (5); when the motorcycle is moving, the motors will supply energy to charge the battery in real time; the operation of the set causes the wheels to rotate counterclockwise with the movement of the motorcycle, using this movement, the motors coupled internally to the wheels generate energy; through the mechanical movement generated by the radial displacement of the wheels, generating the magnetic field necessary to generate energy.

### SUMMARY

Therefore, a new utility model patent was developed that refers to a POWER GENERATOR SYSTEM FOR SELF-CHARGING BATTERIES IN ELECTRIC VEHICLES, which refers to a system similar to that of the aforementioned invention patent, of an energy generating engine for motorcycles, however, the present patent application concerns an energy generating system for self-charging batteries for electric vehicles.

As already highlighted in the patent presented previously, in this one, we also highlight that the car's alternator is the part responsible for converting the mechanical energy generated by the movement of the engine, into electrical energy for use in the vehicle's electronic components and for recharging the battery.

For example, when we turn on the ignition, the car battery supplies the charge to the starter motor, feeds the headlights, wipers, glass, car sound system and electronic injection. However, with so much demand, the battery alone would not be able to cope and the energy would run out quickly.

The energy conversion carried out in the car's alternator serves to meet part of the demand and recharge the battery while the vehicle is in motion, ensuring sufficient charge to activate the ignition engine whenever the car has to be started.

In this process, a belt connected to the alternator pulley rotates in the car's engine, applying mechanical energy to the alternator, which at the same time receives energy from the battery to create a magnetic field between the rotor and stator coils.

Through the electromagnetism generated in the assembly, mechanical energy is converted into electrical energy, with the stator passing an alternating current to the diode plates, which transform it into a direct current, passing through the voltage regulator to restrict the voltage in the working range of the car electrical system.

When the car's alternator does its job, the energy generated is redistributed to the car's electrical system. This will be responsible for powering the various electronic components and recharge the battery while the vehicle is in motion.

The principle applied and components used in the present patent are basically the same as those applied to electromagnetic induction motors, which is defined as the phenomenon in which a conductor is passed through by an induced electric current when immersed in a region of oscillating magnetic field flow.

Electromagnetic induction is applied to alternating current generators, transformers and electric motors. Alternating current generators operate according to Faraday electromagnetic induction.

These generators are present in different types of electrical plants, and the common factor in all of them is that electrical energy is obtained from the conversion of mechanical energy.

In hydroelectric plants, for example, falling water transforms the gravitational potential energy of a large mass of water into kinetic energy. This energy produces the rotational movement of the generator blades, connected to powerful magnets and large conductive coils.

Transformers are devices that make direct use of the phenomenon of electromagnetic induction. These devices only work with alternating electrical currents and are made up of an iron bar, generally U-shaped, wrapped around two coils, with different numbers of turns.

When the electric current passes through the first winding, a magnetic field is produced by the coil, which is then concentrated and transmitted through the iron bar. The second coil, exposed to the oscillating magnetic field, generates an induced magnetic field, opposite to that transmitted by the iron bar.

The difference between the number of turns on each side of the iron bar causes the intensity of the induced electrical current to be different in the two coils, however, the electrical power in each of them is the same, thus increasing it. if the electric current, a potential drop appears and vice versa.

This is how transformers operate: they can step down or reduce the intensity of the electrical current according to the proportion between the number of windings in each of their coils.

Electric motors operate as inverted electrical generators, that is, instead of converting mechanical energy into electricity, they produce mechanical energy from electrical energy. In this case, instead of using the rotation of a shaft to generate electricity, we pass an electric current through a shaft wound by several coils, making it rotate.

The insertion of the dynamo into the vehicle engine saves fuel and helps the environment, as it is a generator that produces direct current, using a commutator, and was the first equipment capable of supplying electricity in the quantity required in various machines and equipment. The network switch generates electricity by inverting the direction of a current is either used to transform an alternating electromotive force into a continuous one, or vice versa.

An electricity generator is called a dynamo, designed to transform mechanical energy in electrical energy. This equipment basically consists of a magnet fixed on a movable axis, around which there is a coil (a long thread wrapped around) turns and made of electrically conductive material, generally copper), without there being physical contact between the coil and the magnet.

Two types of dynamo are used: dynamo in direct current, in which its set provides direct current, that is, current that circulates in only one direction and the second type alternator, or alternating current dynamo, supplier of alternating current, current that circulates in one direction and the other alternately. Some sources refer to this set specifically as an alternator, so the dynamo would only be the direct current generator.

The operating principle of a dynamo is linked to the phenomenon of electromagnetic induction in a flat frame that rotates in magnetic field uniform. This phenomenon can be explained by the Lenz's law, which establishes that the direction of the induced current is opposite to the variation in the magnetic field that generates it. Thus, the variation of an electromagnetic field generates electric current.

In both alternating current and direct current dynamos, the frame is crossed by alternating current. The difference between them is in the way of collecting this current out of the frame. This capture of the current out of the frame, the development of the dynamo begins with the research of Hans Orsted, who, upon observing that the needle of a compass. It oscillated when it was close to a conductive wire carrying an electric current. Later, Michel Faraday became interested in the phenomenon and after some experiments, he observed that when a magnet moves close to an electrical circuit active, the electrical current in the circuit changes.

Vehicle engines function as converters of reciprocating movement of pistons to carry out a rotary movement. This process works with a calculation of force times the object displacement. From this process, the movement of the pistons is transmitted to the vehicle's transmission assembly. When the car receives this force, there is displacement. In the case of the clutch and front brake, it is the steering wheel that influences driving. The pedals assist with the clutch and brakes.

Power generators convert mechanical energy into electrical energy, for this to happen the generator depends on electromagnetic induction. The dynamo is one of the best-known types of energy generators and converts the existing mechanical energy into the rotation of the shaft. This causes the intensity of the magnetic field to oscillate, leading to the induction of voltage in the terminals it has. So when they are subjected to loads, it leads to the circulation of energy.

There are types of generators to convert mechanical energy into electrical energy. This equipment created to generate energy can also be classified into four categories: synchronous generator, direct current generator, induction generator and motor.

On the other hand, wind energy is transmitted and known as a giant of renewable energy, similar to a windmill, the wind turbine is made up of blades that move with the speed of the wind, making the rotor rotate. This, in turn, transmits the multiplied rotation to the generator, which transforms this mechanical energy into electrical energy.

Thus, a new arrangement was developed, now introduced in four-wheeled vehicles, be they cars, trucks, buses, among others. [031] This Utility Model patent for a “POWER GENERATOR SYSTEM FOR SELF-CHARGING OF BATTERIES IN ELECTRIC VEHICLES”, consists of providing a set of equipment applied to vehicles, on the front wheels or rear wheels, called an energy generating engine, with the regenerative energy being supplied by the vehicle's own displacement. Although the dynamo motor has basically the same principle of components that already exist in magnetic induction motors, the dimensions and scale differ completely.

This Utility Model patent application “ENERGY GENERATOR SYSTEM FOR SELF-CHARGING BATTERIES IN ELECTRIC VEHICLES” consists of a configuration applied to vehicles that provide the use of two and up to four motors on the front and rear wheels depending on the configuration of the vehicle.

The objective of this utility model patent application is innovative with the aggregation of motors in the wheels of vehicles, which characterize the vehicle powered by electricity, being cars, vans, trucks and buses.

In view of the problems detected with the engines of vehicles on the market, powered by fossil fuels, those powered by electricity with low autonomy, slow recharging time and the lack of infrastructure for ultra-fast charging stations, the Patent for Utility Model of the “ENERGY GENERATOR SYSTEM FOR SELF-CHARGING BATTERIES IN ELECTRIC VEHICLES”, for better understanding, a description of the construction object is made, with references in the drawings.

For the operation of the present invention patent, the system causes the wheels to rotate in a counterclockwise direction with the movement of the vehicle, by taking advantage of this movement, the motors coupled internally to the wheels generate energy, through the mechanical movement generated by the radial displacement of the wheels, generating the magnetic field necessary for the generation of energy.

The present patent consists of its construction characteristics, the combination of elements and arrangement of parts that will be exemplified in the construction of the set.

### BRIEF DESCRIPTION OF THE DRAWINGS

The attached drawings demonstrate the layout of the system, with the following numerical references being made:

FIG. 1 is a top view of a vehicle where the components are located on the front wheels.

FIGS. 2A-2D presents detailed views of the wheel with motor connected.

FIG. 3A is a perspective view of the wheel with the energy generator.

FIG. 3B is a perspective view of the internal magnetic field generation area in the wheel.

FIG. 4 is a view that demonstrates the assembly of the stator.

### DETAILED DESCRIPTION OF THE EMBODIMENTS

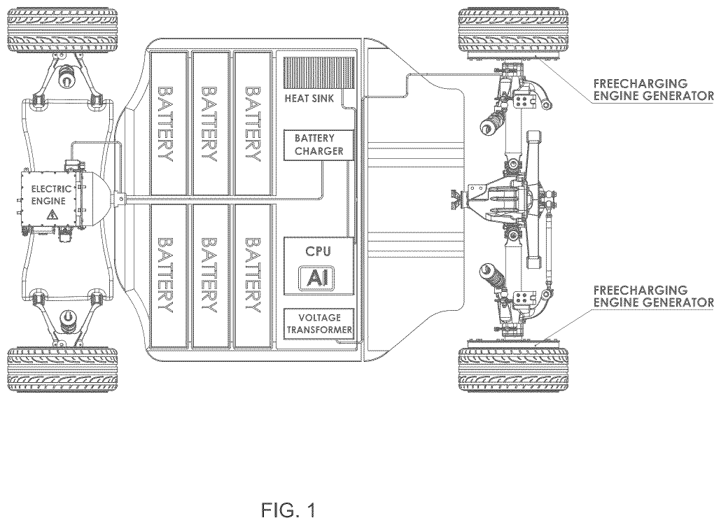

In detail, FIG. 1, this shows a view of the vehicle where the engine on the rear wheels (1), the batteries (2), heatsink (3), consumption manager (4), charger manager (5), energy converter (6) and generators 1 and 2 (7), located on the front wheels.

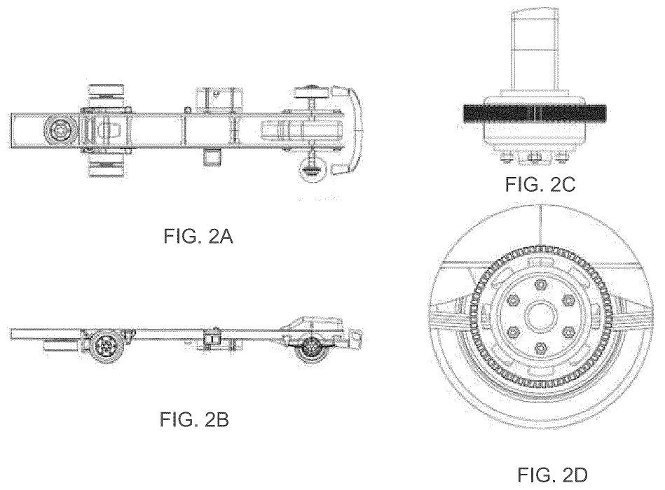

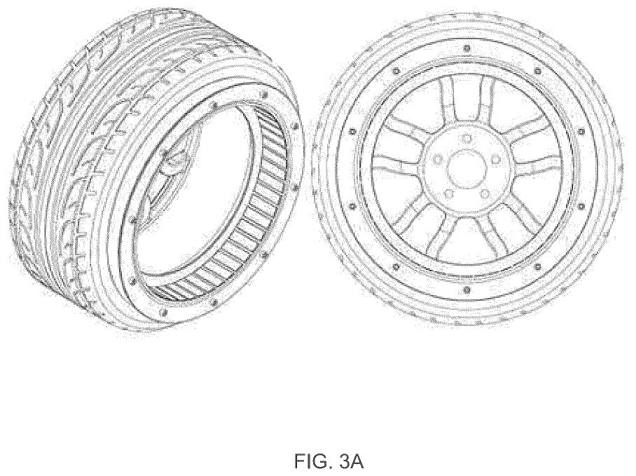

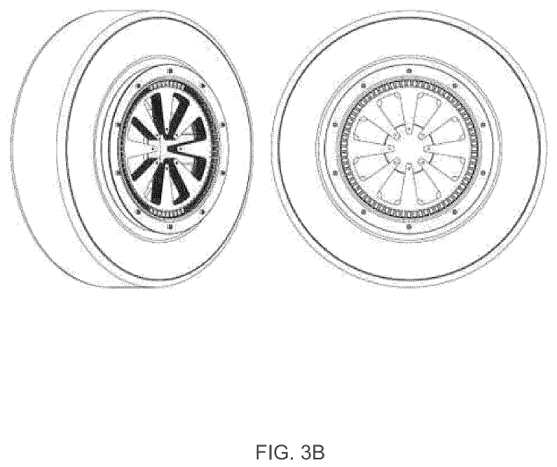

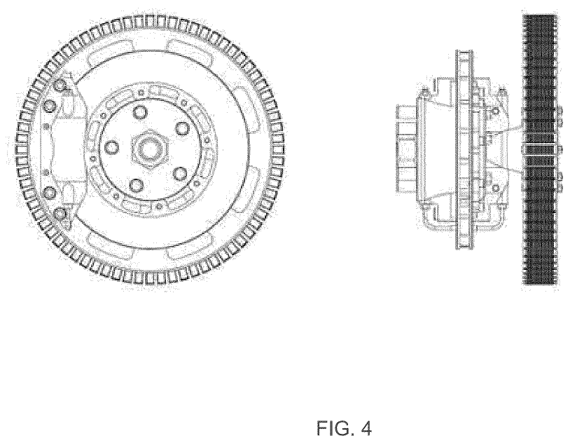

FIGS. 2A, 2B, 2C and 2D, presents details of the wheel with motor connected, where generators 1 and 2 (7) are demonstrated. FIG. 3A shows the perspective of the wheel with the energy generator. In FIG. 3B the internal magnetic field generation area in the wheel (8) and FIG. 4 demonstrates the assembly of the stator.

According to the description and drawings presented, this invention patent aims to increase the autonomy of vehicles in a sustainable way, reaching up to twice the autonomy, bringing territorial freedom to consumers, making trips without the risk of running out of energy on the highway, saving energy in residential recharging and reducing environmental impacts by reducing the dimensions of batteries currently manufactured to meet the demand for autonomy.

What is claimed is:

1. An ENERGY GENERATOR SYSTEM FOR SELF-CHARGING BATTERIES IN ELECTRIC VEHICLES, comprising: a set of electric motors used in four-wheeled vehicles (cars, trucks, tractors, buses), with the insertion of a set of electric coils (stator) and magnetic rotor in order to provide an energy-generating motor system to recharge the battery and increase the autonomy of electric vehicles through displacement, configuration applied to vehicles that provide the use of two and up to four motors in the front and rear wheels, depending on the vehicle, presents the motor in the rear wheels (1), the batteries (2), heatsink (3), consumption manager (4), charger manager (5), energy converter (6) and generators 1 and 2 (7) located in the front wheels, shows the wheel with the motor connected and the perspective of the wheel with the energy generator, the internal magnetic field generation area in the wheel (8) and demonstrates the assembly of the stator.
